(19) United States
(12) Patent Application Publication
(10) Pub. No.: US 2013/0114795 A1
(43) Pub. Date: May 9, 2013

(54) X-RAY WAVEGUIDE, METHOD FOR MANUFACTURING X-RAY WAVEGUIDE, AND METHOD FOR CONTROLLING X-RAY WAVEGUIDE

(71) Applicant: Canon Kabushiki Kaisha, Tokyo (JP)

(72) Inventors: Atsushi Komoto, Moriya-shi (JP); Wataru Kubo, Inagi-shi (JP); Kohei Okamoto, Yokohama-shi (JP); Hirokatsu Miyata, Hadano-shi (JP); Takashi Noma, Hadano-shi (JP)

(73) Assignee: CANON KABUSHIKI KAISHA, Tokyo (JP)

(21) Appl. No.: 13/623,617

(22) Filed: Sep. 20, 2012

(30) Foreign Application Priority Data
Sep. 22, 2011 (JP) 2011-206998
Oct. 17, 2011 (JP) 2011-227973

(51) Int. Cl. G21K 1/00

(52) U.S. Cl. CPC G21K 1/00
USPC 378/145; 29/592

(57) ABSTRACT

An X-ray waveguide includes a core having a periodic structure in which basic structures made of a plurality of materials having different real parts of refractive indexes are periodically disposed, a cladding formed on an outer side of the core to confine X-rays in the core through total reflection and including at least a portion with a gap between the cladding and the core, and a driving unit which drives at least a portion of the cladding or the core to change a distance of the gap. A critical angle for total reflection of the X-rays in the interface between the cladding and the gap is larger than a Bragg angle corresponding to the periodic structure of the core, and a critical angle for total reflection in an interface between a plurality of ingredients which form the periodic structure of the core is smaller than the Bragg angle.

### BACKGROUND OF THE INVENTION

1. Field of the Invention

The present invention relates to an X-ray waveguide for propagating X-rays, a method for manufacturing an X-ray waveguide.

2. Description of the Related Art

When dealing with electromagnetic waves having short wavelengths of several tens of nanometers or less, a difference in refractive index between materials for such electromagnetic waves is very small as 10⁻⁴ or less, and hence the critical angle for total reflection is also very small. To control the electromagnetic waves including X-rays, large-scale space optical systems have been used, and are still mainly used.

As a main part included in the spatial optical systems, there is a multilayer reflector in which layers of materials having different refractive indexes are alternately stacked. The multilayer reflector is used for beam shaping, spot-size conversion, and wavelength selection.

For such mainly used space optical systems, X-ray waveguides that confine electromagnetic waves to a core surrounded by a cladding so that the electromagnetic waves can easily propagate therethrough have recently been proposed to miniaturize the optical systems and improve their performance.

Specifically, a study on a thin-film waveguide having a one-dimensional structure in which cladding layers sandwich a core layer has been published by Salditt, T., Krüger, S. P., Fuhse, C. & Bähtz, C. in an article entitled “High-transmission planar x-ray waveguides”, Physical Review Letters 100 (2008), (herein “Non-Patent Document 1”). Also, a study on an X-ray waveguide having a two-dimensional confinement structure in which a fibrous core passes through a cladding material has been reported by Jarre, A. et al., in an article entitled “Two-Dimensional Hard X-Ray Beam Compression by Combined Focusing and Waveguide Optics”, Physical Review Letters 94 (2005), (herein “Non-Patent Document 2”).

However, the X-ray waveguides described in the above-referenced articles have issues to be improved. In both of Non-Patent Documents 1 and 2, a zero-dimensional mode having the smallest propagation angle has been widely used among waveguide modes to reduce energy loss of X-rays. Since a refractive index difference (real part) between materials is very small in the electromagnetic waves in an X-ray region, a propagation angle of a zero-dimensional mode is decreased. As a result, it is necessary to manufacture a very small core in the X-ray waveguide.

For this reason, X-rays to be propagated are small in area, X-ray beams emitted from the X-ray waveguide are small in size, and a space range of spatial coherence that is one of characteristics of a waveguide is also restricted. In addition, in the case of the X-ray waveguide having a two-dimensional confinement structure, as in Non-Patent Document 2, it has been difficult to manufacture a core having a desired size of several tens of nanometers.

In addition, the X-ray waveguides show fixed X-ray waveguide characteristics, which are determined by the configuration of the waveguide such as materials of the cladding and the core and the size of the cross-section of the core, and cannot modulate the X-ray waveguide characteristics by manipulation from the outside.

### SUMMARY OF THE INVENTION

The present invention is directed to an X-ray waveguide capable of generating X-rays having a high space range of spatial coherence and also modulating waveguide characteristics of X-rays by manipulating from the outside.

According to an aspect of the present invention, there is provided an X-ray waveguide including a core having a periodic structure in which basic structures made of a plurality of substances having different real parts of refractive indexes are periodically disposed, claddings formed on the outer side of the core to confine X-rays in the core through total reflection, a gap formed at least a portion between the cladding and the core, and a driving unit configured to drive at least a portion of the cladding or the core to change the distance of the gap, wherein the critical angle for total reflection of the X-rays at the interface between the cladding and the gap is larger than the Bragg angle corresponding to the structural period of the core, and the critical angle for total reflection at the interface between the plurality of the substances having different real parts of refractive indexes, which form the periodic structure of the core, is smaller than the Bragg angle.

According to another aspect of the present invention, there is provided an X-ray waveguide including a plurality of components which include a cladding portion and a core portion in which a plurality of substances having different real parts of refractive indexes are periodically disposed on the cladding portion, wherein the critical angle for total reflection at the interface between the cladding portion and the core portion is larger than the Bragg angle corresponding to the structural period of the core portion for X-rays with the same wavelengths, and the critical angle for total reflection at the interface between the plurality of substances having different real parts of refractive indexes, which form the core portion, is smaller than the Bragg angle, and a position control unit configured to control the positional relationship between at least one of the first component of the plurality of components and the second component facing the first component, wherein the plurality of components face each other with the core portions set to an inner side thereof, and the structural period of the core portions of the facing components is the same to each other.

According to yet another aspect of the present invention, there is provided a method for manufacturing an X-ray waveguide, the method including preparing a component of an X-ray waveguide by forming a core portion in which a plurality of substances having different real parts of refractive indexes are periodically formed on a cladding portion, disposing the plurality of the components having the core portions with the same structural period so as to face the core portions each other, and installing a mechanism capable of controlling the positional relationship between at least one of the first components and the second component facing the first component.

According to yet another aspect of the present invention, there is provided a method for controlling an X-ray waveguide in which a plurality of components, which includes cladding portions and a core portion in which a plurality of substances having different real parts of refractive indexes are periodically formed on the cladding portion, the method includes disposing the plurality of components so as to facing the core portions each other and controlling the positional relationship between at least one of the first components and the second component facing the first component and resonating X-rays which guide based on the periodic structure of the core portion.

Further features and aspects of the present invention will be shown in the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are schematic diagrams illustrating an X-ray waveguide according to an exemplary embodiment of the present invention.

FIG. 2 is a diagram illustrating an X-ray electric field intensity distribution in a periodic structure of the X-ray waveguide.

FIG. 3 is a schematic illustration of an X-ray waveguide according to an exemplary embodiment of the present invention without a gap between the core and the cladding.

FIG. 4A, FIG. 4B and FIG. 4C are schematic illustrations for explaining the required conditions for the X-ray waveguide according to an exemplary embodiment of the present invention. FIG. 4A illustrates a case where the relationship θ_{B}<θ_{c-total} is satisfied. FIG. 4B illustrates the case where the relationship θ_{B}<θ_{c-total} is not satisfied. FIG. 4C illustrates a case where a relationship θ_{c-multi}<θ_{B} is not satisfied.

FIGS. 5A and 5B are diagrams illustrating an X-ray electric field intensity distribution and a dependence of propagation loss on the number of periods for an X-ray waveguide with no gap between the core and the cladding.

FIG. 6 is a schematic illustration of an X-ray waveguide according to an exemplary embodiment of the present invention with a gap between the cladding and the core with a one dimensional periodic structure.

FIGS. 7A, 7B and 7C are diagrams illustrating dependency of the electric field intensity distribution of the X-ray waveguide on the distance of the gap, according to an exemplary embodiment of the present invention.

FIG. 8 is a schematic illustration of an X-ray waveguide according to an exemplary embodiment of the present invention with a mobile gap between the cladding, the core with a one dimensional periodic structure and a driving unit configured to change the gap distance between the core and the cladding.

FIGS. 9A, 9B and 9C are schematic illustrations of the configuration of the periodic structure used in the core portion of the X-ray waveguide.

FIG. 10 is a schematic illustration of the roughness of an interface between the core and the cladding of a surface side.

FIG. 11 is a schematic illustration of an example of a configuration of the X-ray waveguide according to the second exemplary embodiment.

FIGS. 12A and 12B are schematic illustration of a principle of the X-ray waveguide according to the second exemplary embodiment.

FIG. 13 is a schematic illustration of a shape of the X-ray waveguide including more than two components.

FIGS. 14A and 14B are diagrams showing the change in X-ray intensity of waveguides by the change of the gap distance according to a first and second exemplary embodiment of the present invention.

FIG. 15 is a schematic diagram illustrating control of a position of a fixed first component relative to an incident X-ray.

FIG. 16 is a schematic diagram illustrating a mechanism configured to adjust a positional relationship of the second component to the first component.

FIG. 17 is a schematic diagram illustrating an entire configuration and control axis of the waveguide.

### DESCRIPTION OF THE EMBODIMENTS

Various exemplary embodiments, features, and aspects of the invention will be described in detail below with reference to the drawings.

An X-ray waveguide according to an exemplary embodiment of the present invention includes a core configured to have a periodic structure in which basic structures made of a plurality of materials having different real parts of refractive indexes are periodically provided, the cladding formed on an outer side of the core to confine X-rays in the core through total reflection, a gap formed between at least a portion of the cladding and the core, and a driving unit configured to drive at least a portion of the cladding or the core to change the gap distance, wherein the critical angle for total reflection of the X-rays in the interface between the cladding and the gap is higher than the Bragg angle corresponding to the structure period of the core, and the critical angle for total reflection in the interface between a plurality of ingredients having different real parts of refractive indexes, which form the periodic structure of the core, is also smaller than the Bragg angle.

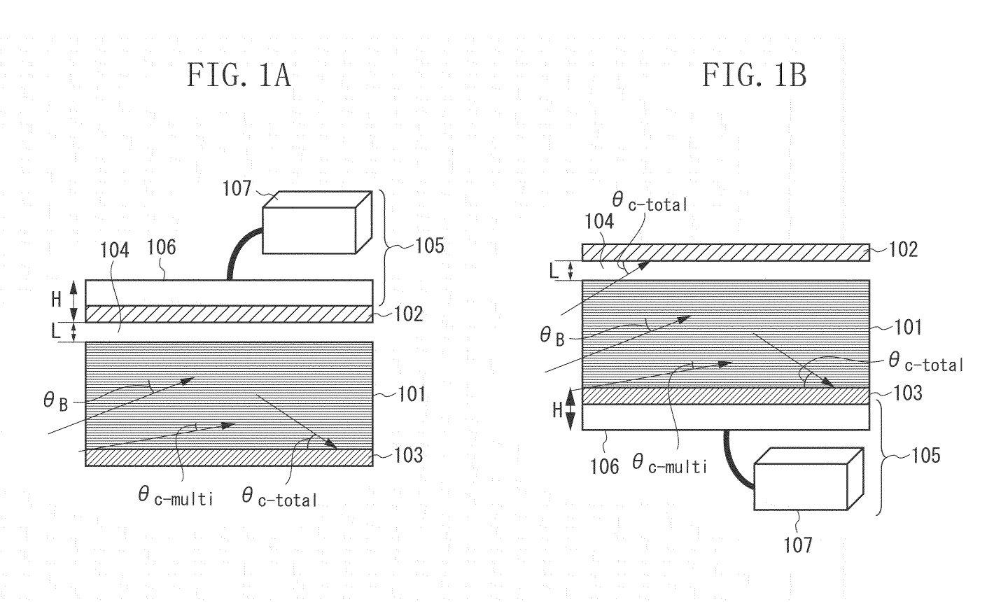

FIGS. 1A and 1B are schematic diagrams illustrating an X-ray waveguide according to an exemplary embodiment of the present invention. As illustrated in FIG. 1A, the X-ray waveguide according to the present exemplary embodiment includes a core 101, a first cladding 102 (upper cladding) formed at a predetermined distance L from the core 101 and a second cladding 103 (lower cladding) formed at an outer side of the core 101, a gap 104 formed between the cladding 102 and the core 101, and a driving unit 105 configured to drive the cladding 102 to change the distance L of the gap 104.

According to the present exemplary embodiment, the driving unit 105 is characterized in that it changes distance of the gap by driving at least a portion of the cladding or by integrally driving other than the portion of the cladding and the core.

The X-ray waveguide according to the present exemplary embodiment is an X-ray waveguide that uses a core 101 with a periodic structure, which allows the use of a waveguide mode that is resonant with the periodic structure. The gap 104 is provided between the core 101 and cladding 102. In addition, the characteristics of the X-ray waveguide such as guided X-ray intensity can be modulated by the driving unit 105 which enables to change the distance L of the gap 104.

FIG. 1A is a diagram illustrating an exemplary embodiment, in which the driving unit 105 is configured to drive only one of the claddings 102. FIG. 1B is a diagram illustrating an exemplary embodiment, in which the driving unit 105 is configured to integrally drive the other cladding 103 and the core 101. In any case, the distance L of the gap 104 can be adjusted by linear movement along the H direction by the driving unit 105. The cladding 102 to be driven (see FIG. 1A) or a combination of the cladding 103 and the core 101 to be integrally driven (see FIG. 1B) is closely fixed on the driving unit 105. The driving unit 105 is composed of a driving stage unit 106 on which the component to be driven is closely fixed, and a control unit 107 to control the driving.

In the present exemplary embodiment, the term “X-rays” refers to electromagnetic waves of a wavelength region in which a material has a real part of refractive index of 1 or less. More particularly, in the present exemplary embodiment, the term “X-rays” refers to electromagnetic wave having wavelengths of 100 nm or less, including extreme ultraviolet (EUV) light. Since such short-wavelength electromagnetic waves have very high frequencies, electrons in the outermost shells of materials cannot respond to the electromagnetic waves. Thus, the short-wavelength electromagnetic waves differ from those with a wavelength equal to or longer than the wavelengths of ultraviolet light, such as visible lights and infrared rays. It is known that real part of refractive index of materials is less than 1 for X-rays. The refractive index n of a material for X-rays is commonly represented as in Expression 1:

n=1−δ−i\tilde{β}=ñ−i\tilde{β} [Expression 1]

where δ is the amount of shift from a real part of 1, and \tilde{β} is the imaginary part that relates to absorption. Unless the intrinsic energy absorption edge of atoms contributes, δ is generally proportional to an electron density ρₑ of a material. Thus, a refractive index of a material having a higher electron density has a smaller real part. The real part of the refractive index is represented by:

ñ=1−δ

In addition, the electron density ρₑ is proportional to an atomic density ρₐ and an atomic number Z. As described above, the refractive index of a material for X-rays is expressed as a complex number. In this specification, however, the real part is referred to as “the real part of refractive index,” and the imaginary part is referred to as “the imaginary part of refractive index.”

In the X-ray region, a material having the highest real part of refractive index 1 is vacuum, typical gases such as air have substantially the same refractive index as vacuum. The refractive index of almost all materials except for gases have real part of less than 1. In this specification, the words “material”, and “substance” are also applied to vacuum and gases such as air.

The X-ray waveguide according to the present exemplary embodiment confines X-rays therein through total reflection at the interface between the core and the cladding, and guides the X-rays. To achieve the total reflection, the real part of refractive index of the core at the interface between the core and the cladding is higher than the real part of refractive index of the cladding in the X-ray waveguide according to the present exemplary embodiment. In this case, the critical angle for total reflection is expressed as an angle θ_{c} formed between the incident beam and the interface where the incident beam is reflected.

The X-ray waveguide according to the present exemplary embodiment is characterized in that the periodic structure made of a plurality of materials having different real parts of refractive indexes is used as the core. Since the core has a periodic structure, a waveguide mode, which resonates with the periodic structure, can be formed.

When such periodic structures having different real part of refractive indexes have an unlimited number of periods, a photonic band is formed in the relationship between the propagation constant and the angular frequency of X-rays, and only the X-rays resonating with the periodicity of the core can be present in the structure. At least one of the plurality of materials having different real parts of refractive indexes is preferably an oxide.

The periodic structure is a structure in which basic structures are periodically arranged, which may include a one-dimensional periodic structure in which basic layered structures are stacked, a two-dimensional periodic structure in which cylindrical structures are used as the basic structures to be arranged, and a three-dimensional periodic structure in which cage structures are used as the basic structures to be arranged.

The waveguide mode formed in the X-ray waveguide according to the present exemplary embodiment is derived from multiple reflection corresponding to each dimension of the periodic structures. Also, because this mode is originated from the periodicity, the positions of antinodes and nodes in the distribution or electric field intensity of X-rays correspond to the positions in each material region constituting the periodic structure. In this case, the propagation loss of a waveguide mode for which the electric field intensity of X-rays is concentrated on a material having a lower electron density in the periodic structure is lower than those of the other waveguide modes, and thus it is possible to selectively extract the resonant waveguide mode.

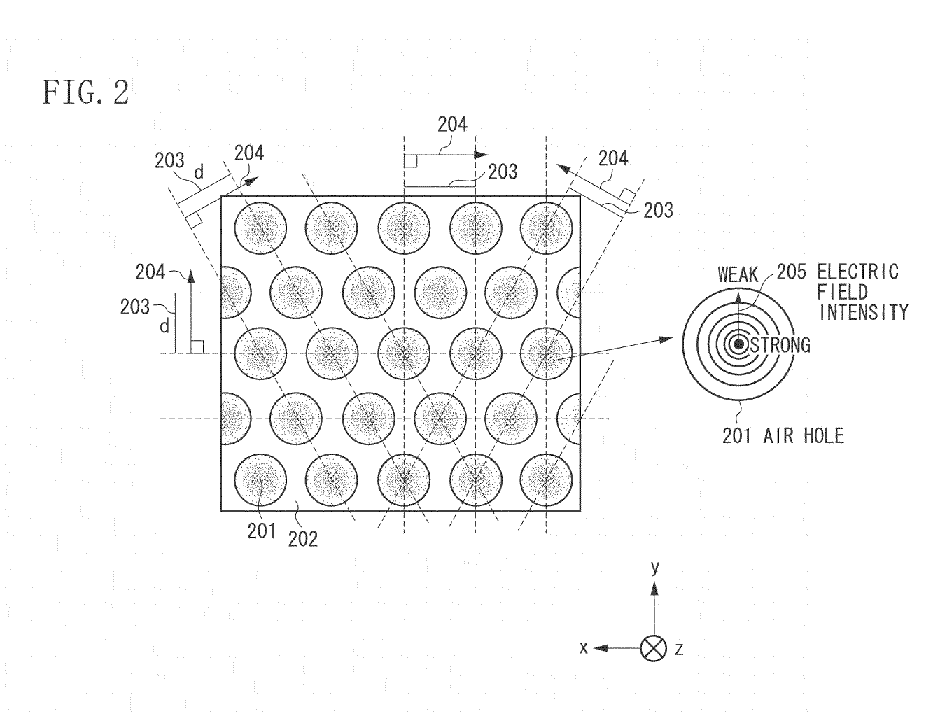

FIG. 2 illustrates an example of the electric field intensity distribution of X-rays in a periodic structure in which cylindrical air holes 201 extending in one direction in silica 202 are formed into a two-dimensional triangular lattice structure in the x-y plane, which is perpendicular to the length direction (z direction) of the holes.

In FIG. 2, the dashed lines indicate the structure period d, and white and black shading in the cylindrical air hole 201 represents the distribution of the electric field intensity of X-rays. The right-hand section of FIG. 2 shows a magnified representation of the electric field intensity distribution for one of the waveguide modes generated in the material. White and black circles correspond to strong and weak strengths of the electric field intensity, respectively. The electric field intensity is described by the distances between the plural circles in the air hole instead of the white and black shades.

The intervals between the plural circles in the cylindrical air hole 201 represent electric field intensities 205 of X-rays. This shows the electric field intensity distribution for one of the waveguide modes generated in the material. Narrow intervals between the plural circles correspond to high electric field intensity, and wide intervals correspond to low electric field intensity. In the central region of the air hole 201, the intervals between the circles are narrow, which means that the electric field intensity 205 is high. The intervals between the circles increase from the central region in the radial direction of the hole. At the circumferential region of the hole, the intervals between the circles are wide, which means that the electric field intensity is low.

Regions having the maximum and minimum electric field intensities are periodically repeated in the x and the y directions, and the electric field are concentrated on the hole having the periodic structure (a basic structure 205 having a periodic structure). The air hole 201 represents a basic structure that forms a periodic structure. The arrow 204 represents the direction of the periodicity.

When X-rays having an electric field intensity distribution which resonates with such a periodic structure are confined in the core by the cladding, a waveguide mode resonating with the periodicity is generated to guide the X-rays. The waveguide mode is referred to as the periodic resonance waveguide mode.

On the other hand, the core of the X-ray waveguide according to the present exemplary embodiment does not have an infinitely repeating periodic structure but a periodic structure having a limited thickness, which is sandwiched between the claddings. Therefore, there are waveguide modes generated when the entire core is used as a uniform medium having an average refractive index, in addition to the periodic resonance waveguide mode. These are referred to as the uniform waveguide modes.

compared with the uniform waveguide modes, the periodic resonance waveguide mode generated by the X-ray waveguide of the present exemplary embodiment is lower in loss than the uniform waveguide mode around the periodic resonance waveguide mode, and has spatial coherence. To generate the periodic resonance waveguide mode in addition to the uniform waveguide modes through the total reflection at the interface between the cladding and the core, the X-ray waveguide of the present exemplary embodiment is designed to satisfy the following requirements.

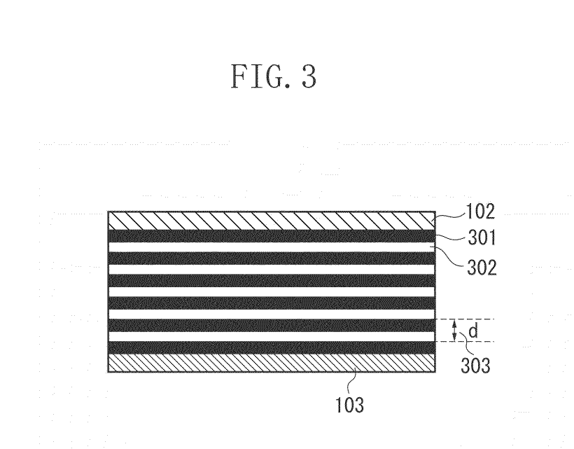

The explanation for the requirements is described for the waveguide without a gap between the core and the cladding shown in FIG. 3. In FIG. 3, 301 and 302 show the materials with low and high real part of refractive index, respectively. At the interface between the cladding and the core, the real part of refractive index of a material in the cladding side is set to n_{clad} and the real part of a refractive index of a material in the core side is set to n_{core}. Here, the critical angle θ_{c-total} (°) for total reflection at the core-cladding interface in the direction parallel to the plane of a film is represented by Expression 2, when the relationship n_{clad}<n_{core} is satisfied.

$${θ}_{c \text{-} total} = \frac{180}{π} arccos ( \frac{{n}_{clad}}{{n}_{core}} ) \qquad [ Expression 2 ]$$

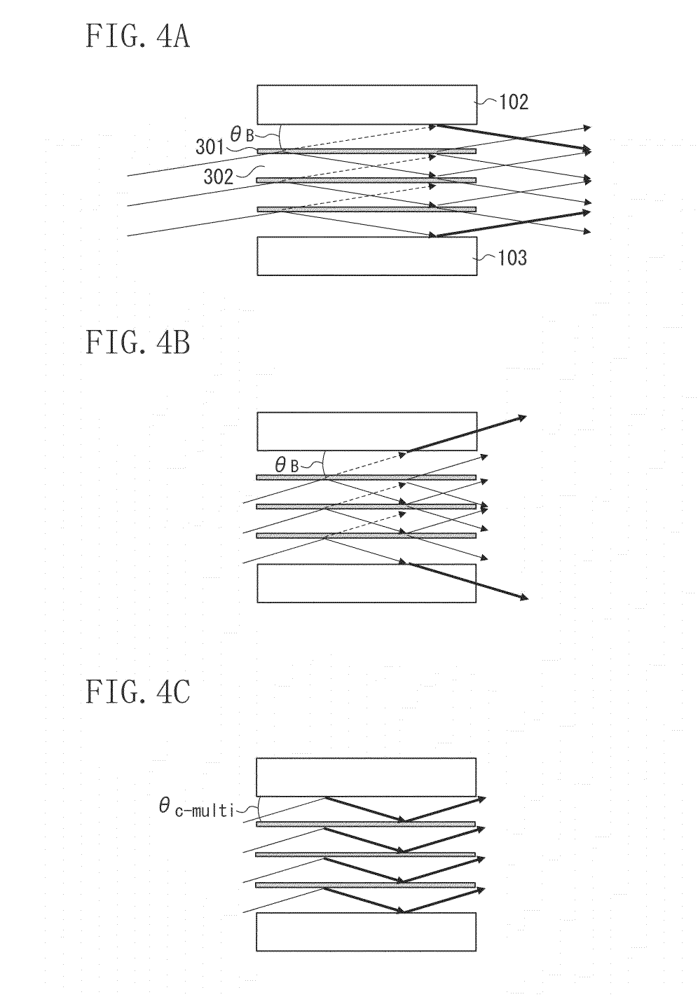

Also, for a structural period d of the periodic structures constituting the core (303 in FIG. 3), the Bragg angle θ_{B} (°) is defined as in the following Expression 3, regardless of the presence of multiple diffraction in the core.

$${θ}_{B} \approx \frac{180}{π} arcsin ( m \frac{λ}{2 d} ) \qquad [ Expression 3 ]$$

where m is an order (natural number), and λ is a wavelength of X-rays. Physical property parameters of the materials forming the X-ray waveguide of the present exemplary embodiment, structural parameters of the waveguide, and wavelengths of X-rays need to satisfy the relationship: θ_{B}<θ_{c-total}. This is explained using FIGS. 4A and 4B. FIG. 4A is the case when the above relationship, θ_{B}<θ_{c-total}, is satisfied. It is shown that the X-rays that underwent multiple diffraction are confined by the total reflection at the core-cladding interface. On the other hand, FIG. 4B shows the case when this relationship is not satisfied. As shown in the figure, the X-rays underwent multiple diffraction go through the core-cladding interface and are not confined in the core.

According to the present exemplary embodiment, another condition to be described as follows needs to be satisfied.

When the periodic structure is composed of a plurality of substances having different real part of refractive index, it is necessary to consider the reflection of X-rays at the interface between the respective substances. The multiple reflection caused by the periodic structure needs to take place to work the X-ray waveguide of the present exemplary embodiment.

When the total reflection takes place at the interfaces between the materials forming the periodic structure, for example in one-dimensional periodic structure, X-rays are confined in the material having the highest refractive index among the materials forming a stacked structure, thereby interrupting multiple interference. As a result, it is not possible to achieve the object of the present exemplary embodiment. In other words, a unit forming the periodic structure functions as the multiple X-ray waveguide based on total internal reflection, which is the same structure as conventional planar waveguides.

Therefore, a condition that the critical angle for total reflection in the interface between the substances having different real part of refractive index forming the periodic structure of the core should be lower than the Bragg angle is required. The condition is expressed by the following expression.

For the critical angle for total reflection between the substances having different real part of refractive index forming the periodic structure of the core, θ_{c-multi} (°), θ_{c-multi}<θ_{B} is satisfied. This is also explained using FIG. 4C. FIG. 4C corresponds to the case when this relationship is not satisfied. It is shown that the X-rays are confined in each layer with the higher real part of refractive index, and does not cause multiple diffraction.

When all the conditions as described above are satisfied, the waveguide mode confined by the total reflection at the interface between the cladding and the core is locally present in the core. An effective propagation angle measured in a direction parallel to a film is expressed by the following expressions:

$$\tilde{θ} ( ° )$$

$$\tilde{θ} = \frac{180}{π} arccos ( \frac{{k}_{z}}{{k}_{0}} )$$

wherein k_{z} represents the wavenumber vector (propagation constant) of the waveguide mode in the propagation direction, and k₀ represents the wavenumber vector in vacuum.

With the X-ray waveguide of the present exemplary embodiment as described above, the X-rays propagating on the waveguide mode which resonates with the periods of the regular structure by multiple interference are selectively guided with a low loss. Phases of the X-rays are coherent throughout the entire thickness of the core. That is, the X-rays become spatially coherent, and are emitted from the section of the waveguide with a small divergence angle, which is determined by the wavelengths of X-rays and the structural period of the core.

Since the periodic resonance waveguide mode is lower in loss than the uniform waveguide mode around the periodic resonance waveguide mode, it is possible to guide mode-selected X-rays. This is demonstrated by the simulation on the X-ray waveguide in which a one-dimensional periodic structure having a layered structure, as shown in FIG. 3. The claddings 102 and 103 are gold, and the core with a layered structure is consisted of silica 301 and surfactant 302.

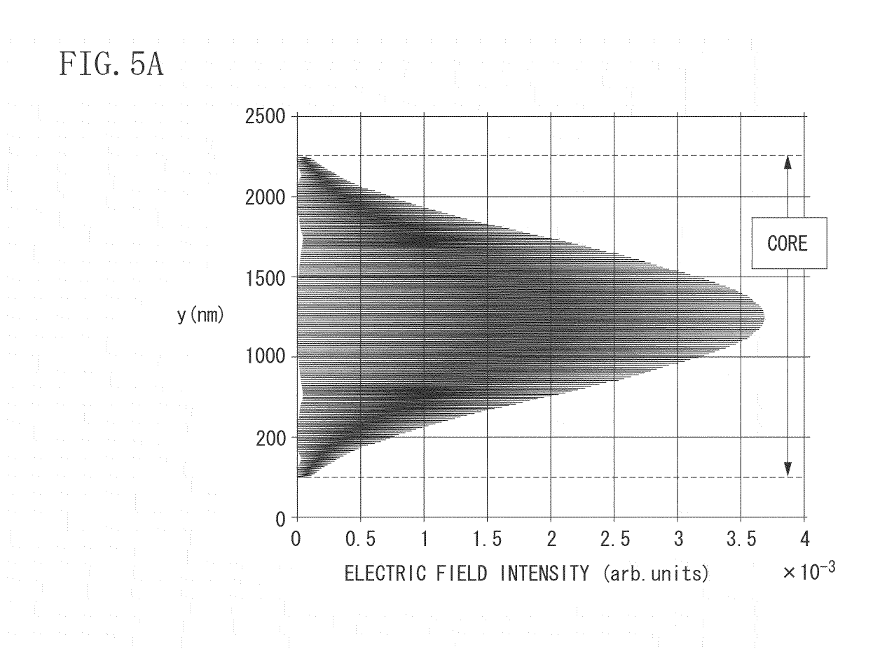

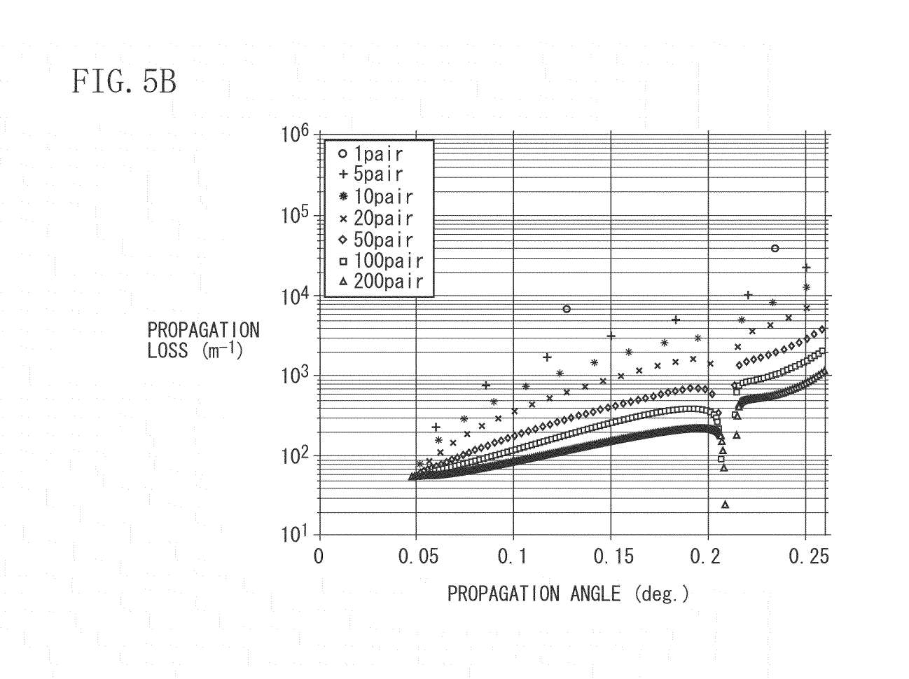

FIG. 5A illustrates X-ray electric field intensity distribution, and FIG. 5B illustrates dependence of propagation loss on the number of periods for an X-ray waveguide. FIG. 5A is the results of a simulation by the finite element method for the electric field intensity distribution in the core for the periodic resonance waveguide mode in the waveguide shown in FIG. 3 with a structure period d of 10 nm. The X-ray energy in the calculation is 17.5 keV. In the above waveguide, θ_{c-total}=0.243°, θ_{B}=0.203° and θ_{c-multi}=0.058° for X-rays at 17.5 keV, and the conditions of θ_{B}<θ_{c-total} and θ_{c-multi}<θ_{B} are satisfied.

The propagation angle of the waveguide mode is slightly smaller than the Bragg angle of the periodic structure, θ_{B}, and the electric field is concentrated on the central region of the core. Therefore, leakage of energy into the cladding is small, and the coherent waveguide mode is realized. As illustrated in FIG. 5B, the periodic resonance waveguide mode has an advantage in the propagation loss. As the number of the period increases, the reduction of the propagation loss becomes significant. The number of the period of the periodic structure in the core of the X-ray waveguide according to the present exemplary embodiment is preferably 20 or more.

The X-ray waveguide according to the present exemplary embodiment confining X-rays may be one-dimensional in which a film-shaped core is sandwiched between claddings, or may be two-dimensional in which a core with a circular or rectangular cross-section perpendicular to the waveguide direction is surrounded by the cladding. In the two-dimensional confinement waveguide, X-rays are two-dimensionally confined in the waveguide. Thus, the divergence is suppressed compared to the one-dimensional confinement waveguide, and X-ray beams having a small beam size can also be extracted.

Also, when the periodic structure is the above-described two-dimensional structure (basic structure: a cylindrical structure) or three-dimensional structure (basic structure: cage structure), the electric field intensity distribution resonating with the plural periodicity may be effectively generated in the core.

As described above, the critical angle θ_{c-total} (°) for total reflection in a direction parallel to a plane of a film is represented by Expression (2). Here, the following relation is required: n_{clad}<n_{core}. The material of the cladding of the X-ray waveguide according to the present exemplary embodiment may be composed so that the other structural parameters and physical property parameters of the waveguide satisfy all the conditions for achieving the periodic resonance waveguide mode, as described above.

For example, when mesoporous silica having a two-dimensional periodic structure in which hollow holes are arranged in a triangular lattice shape at a structural period of 10 nm is used as the core, the cladding may be formed of Au, W, Ta, etc.

With these configurations, the X-ray waveguide of the present exemplary embodiment can effectively guide X-rays by forming a periodic resonance waveguide mode which resonates with the periodicity. This periodic resonance waveguide mode allows a low propagation loss and therefore, single-mode propagation where the phase is controlled is achieved.

The X-ray waveguide according to the present exemplary embodiment is characterized in that a gap is disposed between the cladding and the core with a periodic structure. The gap may be filled with a fluid or is under vacuum. The gap is preferably filled with a fluid such as gases or liquids, so that the distance of the gap can be changed. For example, a gas such as air, nitrogen, helium, argon or a liquid such as water, alcohol can be used.

In the present exemplary embodiment, a gas is preferably used as a fluid because of the low electron density that leads to suppression of absorption or diffusion of X-rays.

As described above, as illustrated in FIG. 3, in the waveguide with no gap, the electric field intensity distribution of X-rays is concentrated in the center of the core, which allow the formation of a waveguide mode having a low propagation loss compared with the other adjacent modes.

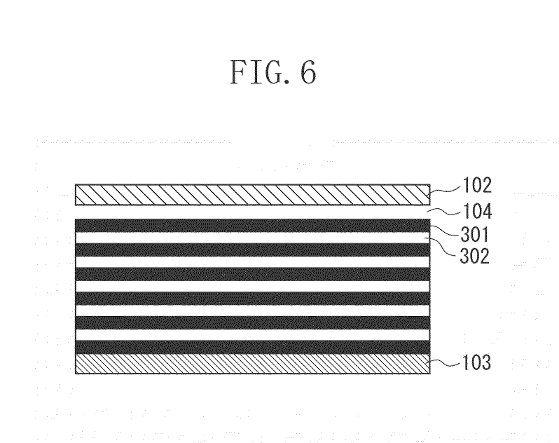

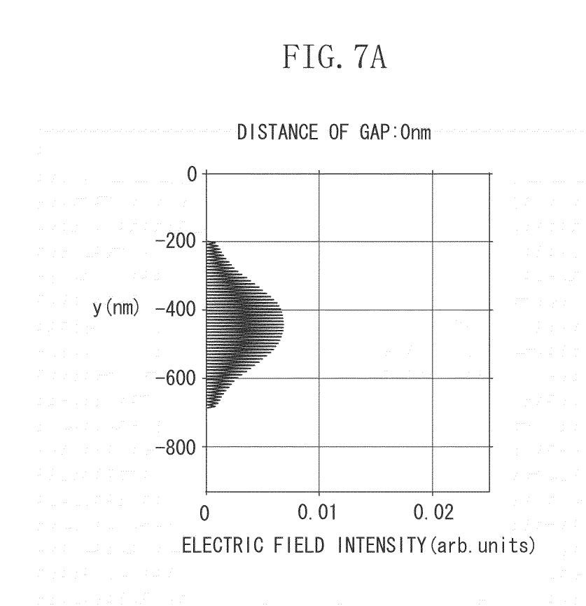

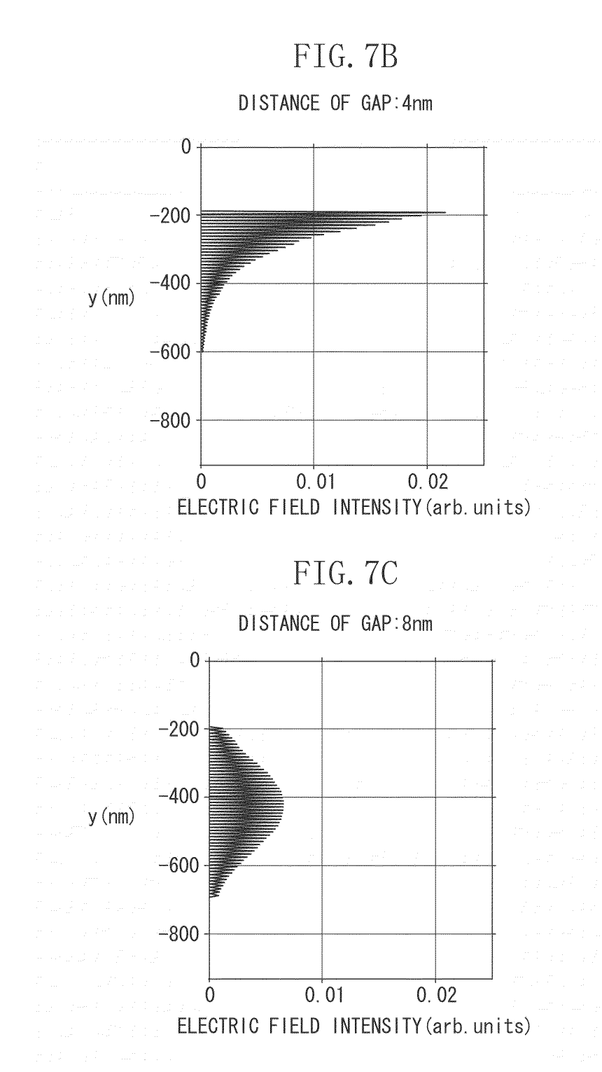

FIG. 6 is a schematic illustration of the X-ray waveguide having a configuration in which the gap 104 filled with air is disposed between the top cladding made of tungsten 102 and the core of the X-ray waveguide with a periodic multilayer structure with a period of 10 nm composed of silica 301 and a surfactant 302. FIGS. 7A, 7B, and 7C are diagrams showing the dependence of the electric field intensity distribution of the X-ray waveguide according to the present exemplary embodiment on the distance of the gap.

Simulations based on the finite element method are performed for X-rays with a energy of 8.04 keV for the X-ray waveguide shown in FIG. 6. The results shown in FIGS. 7A, 7B and 7C are for the gap of 0 nm, 4 nm, and 8 nm, respectively. In the waveguide, θ_{c-total}=0.515°, θ_{B}=0.442° and θ_{c-multi}=0.128° for X-rays at 8.04 keV, and the conditions of θ_{B}<θ_{c-total} and θ_{c-multi}<θ_{B} are satisfied.

In FIG. 7, the upper end of the gap is positioned at the coordinate of y=−200 nm. As illustrated in FIG. 7B with the gap of 4 nm, the X-ray electric field intensity distribution of the periodic resonance waveguide mode is changed, compared with the waveguide with no gap (FIG. 7A).

When the gap has a distance of 4 nm, the electric field intensity distribution is concentrated on the gap position. This is in contrast to the waveguide with no gap in which the electric field intensity distribution is concentrated in the center of the core. Hence, the energy of X-rays is largely lost into the cladding, and consequently, the propagation loss increases to the level comparable to the other modes. That is, this means that the periodic resonance waveguide mode does not selectively propagate.

On the other hand, when the gap distance illustrated is changed to 8 nm, the electric field intensity is concentrated on the central region of the core, just like the case with no gap, as shown in FIG. 7C. Consequently, the propagation loss of the specific periodic waveguide mode is lowered compared to that of the other adjacent waveguide modes. From the results of these simulation, it is shown that the propagation loss of the periodic resonance waveguide mode periodically changes with the distance of the gap.

When the gap is too wide, the characteristics of the periodic resonance waveguide mode becomes unclear, and the propagation loss of X-rays increases. Thus, the gap distance is 100 nm or less, and preferably 50 nm or less.

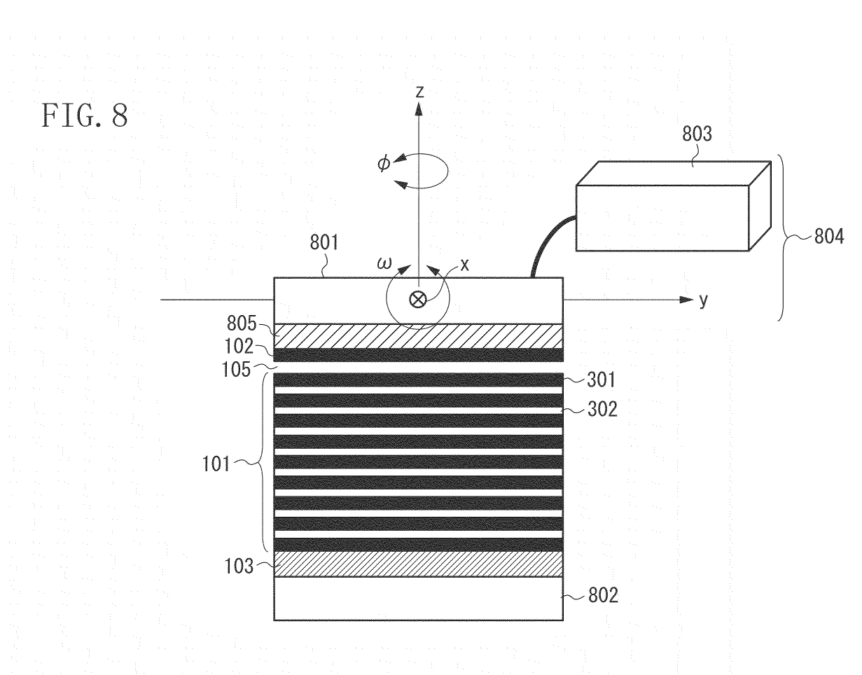

FIG. 8 is a schematic illustrating of a the waveguide of the present exemplary embodiment with a variable gap between the core and the cladding by a driving unit configured to change the gap distance. The X-ray waveguide of FIG. 8 is a detailed drawing of FIG. 1A, which shows the X-ray waveguide consisting of a mobile cladding 102 on a substrate 805 fixed on a driving stage 801, a core 101 with an alternative stacking of low and high real part of refractive indices (301 and 302, respectively) formed on a bottom cladding (103) on a substrate (802), and a gap 104 between the core 101 and the top cladding 102.

As illustrated in FIG. 8, the driving unit 804 is configured to change the gap distance. The driving unit 804 according to the present exemplary embodiment may drive the cladding 102 not only in a single direction but in a plural directions.

In general, the driving unit 804 includes the driving stage 801 that closely fixes the cladding 102 to be driven, and a control unit 803. Also, as long as the driving unit 804 contributes to modulation of the periodic resonance waveguide mode, the driving direction can be optionally selected.

In FIG. 8, the cladding 102 is predominantly moved along the z axis to change the distance of the gap. However, when adjustment of an angle with respect to the waveguiding direction of X-rays (y axis) is required, it is possible to control the angle by the ω-rotation. The ω-rotation also modulates the characteristics of the X-ray waveguide according to the present exemplary embodiment because the ω-rotation brings gradual changes in the X-ray electric field intensity distribution along the propagation direction of X-rays, the ω direction also contributes to the modulation of the characteristics of the waveguide mode.

FIG. 8 illustrates an example in which only the cladding 102 is driven. However, as long as the distance of the gap is changed by driving a portion of the cladding, the other geometry is allowed in the present exemplary embodiment. For example, a case in which both of a portion of the cladding and the core are combined and integrally driven as illustrated in FIG. 1B can also be included.

According to the present exemplary embodiment, a piezo actuator is preferably used as the driving unit configured to change the gap distance between the core and the cladding because precise position control with high resolution is required.

The periodic structure used in the core of the X-ray waveguide according to the present exemplary embodiment is not particularly limited as long as the periodic structure satisfies the above-described configuration of the waveguide according to the present exemplary embodiment. Multilayer films manufactured using a sputtering or evaporation method, periodic structures manufactured by conventional semiconductor manufacturing processes, such as photolithography, electron beam lithography, etching, stacking and junction may be used. Oxides are preferably used as the materials forming the periodic structure because of their durability to oxidative degradation.

Since the difference in refractive index between the plural materials forming the periodic core contributes to the dependency of the waveguide mode modulation on the spacing of the gap, the refractive index of the core material may be properly selected according to the desired characteristics of the waveguides.

As the core of the X-ray waveguide according to the present exemplary embodiment, an organic-inorganic multilayer film or films of mesoporous materials may be preferably used, especially in an aspect of facility of the manufacturing process and the highly regular periodic structure. Porous materials are classified according to diameters of the pores by the International Union of Pure and Applied Chemistry (IUPAC). Porous materials having pores with a diameter of 2 to 50 nm are classified as mesoporous materials. The films of these mesoporous materials are prepared through applying a reactant solution containing a precursor of an oxide and structure-directing agent on a substrate by a conventional process such as coating. These materials have a characteristic that a periodic structure is spontaneously formed by a self-assembly.

For this reason, conventional complicated semiconductor processes are not required, and a periodic structure can be prepared easily with a high throughput. With conventional semiconductor process, it is difficult to form a periodic structure having a size of several tens of nanometers. In particular, it is almost impossible to manufacture such fine periodic structure with more than two three-dimensional periodicity.

The periodic structure used in the present exemplary embodiment is either a organic-inorganic multilayer films or films of the mesoporous materials in which a periodic structure is consisting of inorganic materials and an organic materials or vacancies. The inorganic oxide is preferably used as the inorganic material, and examples of the inorganic oxide include silica, titanium oxide, zirconium oxide. The organic materials include, for example, amphiphilic molecules such as a surfactants, alkyl groups of siloxane oligomers and silane coupling agents.

Examples of the surfactant may include C₁₂H₂₅(OCH₂CH₂)₄OH, C₁₆H₃₅(OCH₂CH₂)₁₀OH, C₁₈H₃₇(OCH₂CH₂)₁₀OH, Tween 60 (Tokyo Chemical Industry Co., Ltd.), Pluronic L121 (BASF), Pluronic P123 (BASF), Pluronic P65 (BASF), Pluronic P85 (BASF). These surfactants may be properly selected to adjust the dimensions of the periodic structure or the structure periods (lattice distances obtained from Bragg diffraction). Table 1 shows the periodic structures prepared using several organic materials (surfactants) to be used.

TABLE 1

| | Dimension of | Structure |
|---|---|---|
| Organic material | periodic structure | period (nm) |
| Pluronic L121 | One-dimensional | 11.6 |
| Pluronic P123 | Two-dimensional | 10.4 |
| Pluronic P85 | Two-dimensional | 9.3 |

When the films of mesoporous materials are formed through self-assembly by application of a precursor reactant solution onto a substrate, the organic material, which directs the formation of a periodic structure, is included in the pores of the mesoporous films. These organic substances can be removed using conventional known methods such as calcination, extraction using an organic solvent, ozone oxidation.

According to the present exemplary embodiment, the organic substances can remain in the pores of the mesoporous films as long as the mesoporous films have desired performance. Since absorption of X-rays are reduced by removing the organic substances, the X-ray waveguide having much less propagation loss can be provided by forming hollow structures.

However, since the mesoporous material film having a higher residual rate of the organic substances may have better structural periodicity, the characteristics of the periodic resonance waveguide mode may be observed more clearly. For these reasons, the residual rate (removal rate) of the organic substances may be properly determined according to the desired waveguide characteristics.

The X-ray waveguide according to a second exemplary embodiment is characterized in that the reduction of X-ray propagation efficiency due to the roughness of the surface of the core is suppressed by combining a plurality of X-ray waveguide components in which a core portion having a periodic structure is formed on a flat cladding portion, and precisely controlling the positional relationship between the X-ray waveguide components.

First, the core portion having a configuration in which periodic structures are formed from a plurality of materials having different real parts of refractive indexes will be described. The phrase “a plurality of materials” used herein includes all combinations that may define a stable periodic structure. As described above, vacuum or air is also included in the definitions of the materials. That is, a material, in which a material and an air gap are alternately used to form a periodic structure may be also used as the core portion of the present exemplary embodiment.

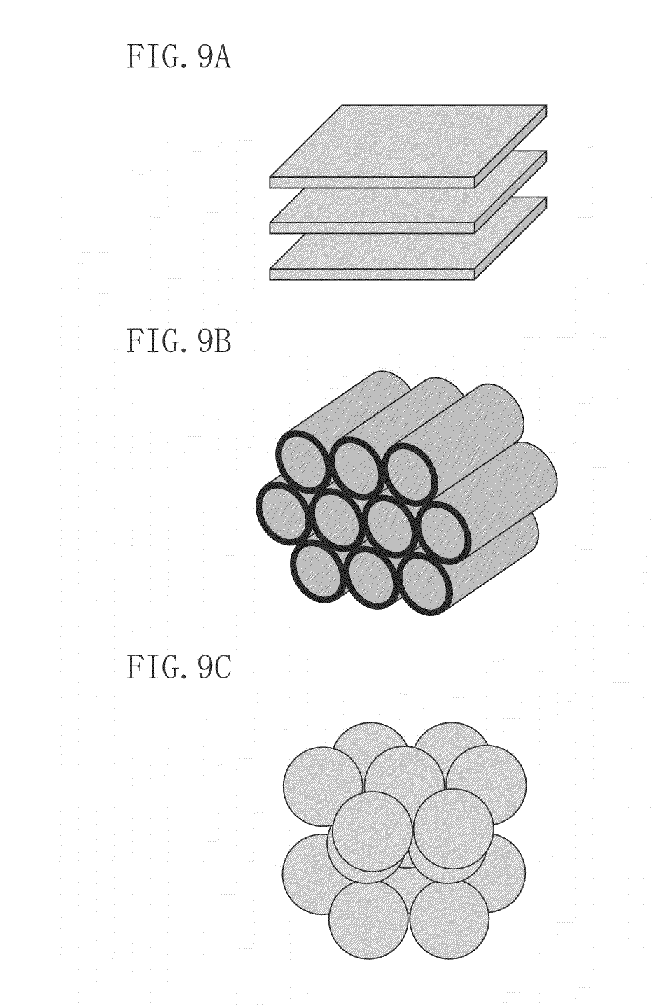

Any dimension of the structure can be employed for the periodic structure. That is, any of the one-dimensional, two-dimensional, and three-dimensional periodic structures may be used. Herein, the one-dimensional periodic structure includes a structure in which a plurality of layered materials has periodicity in a stacking direction, as illustrated in FIG. 9A.

The two-dimensional periodic structure includes a structure in which structure units having infinite length in one direction are regularly disposed two-dimensionally in a section, as illustrated in FIG. 9B. The arrangement of the structure unit includes hexagonal and cubical arrangements.

The three-dimensional periodic structure includes a structure that are closely packed with component units (for example, spheres illustrated in FIG. 9C) in a cubical or hexagonal shape, and a structure such as a double-gyroid structure consisting of a plurality of materials with structural regularity formed by a phase separation.

Also, as described above, the X-ray waveguide should confine X-rays in the core through total reflection at the core-cladding interface to prevent the X-rays, which undergo multiple interference in the core made of a material having a periodic structure, from going out of the core. That is, inevitably, the condition that the Bragg angle corresponding to the periodic structure of the core materials constituting the waveguide be smaller than the critical angle for total reflection in the core-cladding interface is needed, as described before.

Herein, in the X-ray waveguide as described above, X-rays are predominantly propagated on a waveguide mode which resonates with the periodicity of the regular structures through multiple interference because of the selectively low propagation loss. Since the X-rays propagate on the periodic resonance waveguide mode are in-phase throughout the entire thickness of the core, that is, the X-rays become spatially coherent, the X-rays are emitted from the section of the waveguide with a small divergence angle, which is determined by the wavelengths of the X-rays and the structural periods of the core.

Since the X-ray waveguide capable of propagating X-rays on the above-described periodic resonance waveguide mode has a configuration that the multiply interfered X-rays in the core with a periodic structure by total reflection at the interface between the core and the cladding, as described above, reflectivity of X-rays at the interface highly affects the propagation efficiency of the waveguide. Since the X-rays have very short wavelengths, extremely high flatness is required for the interface between the core and the cladding.

However, the surface of the periodic structure used in the core of the X-ray waveguide according to the present exemplary embodiment is not necessarily limited to that with a sufficient flatness. For this reason, a novel configuration of a device enabling propagation of X-rays in the periodic resonance waveguide mode, in which the low flatness of the core surface is not problematic, is needed.

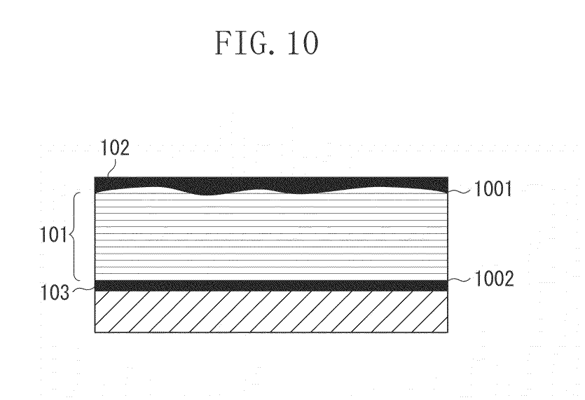

A basic configuration of the X-ray waveguide according to the present exemplary embodiment, which enables the propagation of X-rays on the periodic resonance waveguide mode, is illustrated in FIG. 3. However, in fact, the periodic structure forming the core portion has relatively large surface roughness according to the material to be used. As illustrated in FIG. 10, when the cladding 102 is formed on the core 101, the flatness at the interface between the surface of the core and the cladding (1001) may be lowered.

In this case, the loss at the interface due to the scattering increases, and consequently the confinement effect of X-rays by the cladding is reduced. However, when the periodic structure is formed on a cladding 103 with a sufficient flatness, the flatness of the interface between the bottom of the core and the cladding (1002) can be secured, and consequently, the loss in total reflection can be suppressed at this interface.

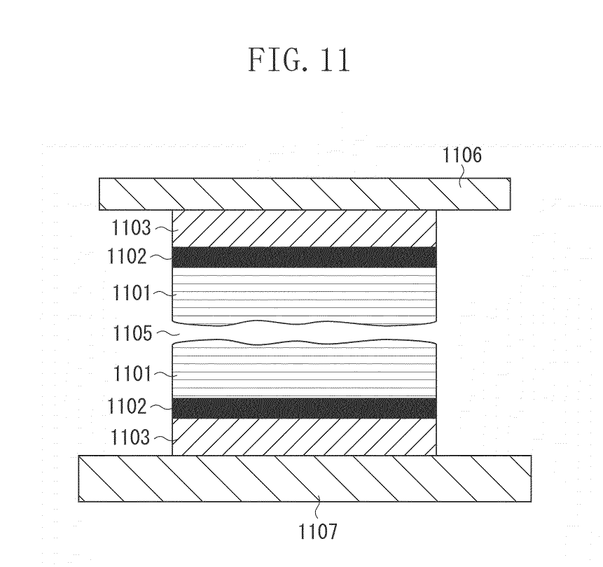

The difference of the X-ray waveguide according to the present exemplary embodiment and the X-ray waveguide capable of guiding X-rays in the periodic resonance waveguide mode having the simplest configuration illustrated in FIG. 3 is that a plurality of components in which the cladding is formed on one surface of the periodic structure forming the core are held to face the core portion each other in the present exemplary embodiment. Hereinafter, description will be made with reference to the schematic illustration of the present exemplary embodiment shown in FIG. 11.

As illustrated in FIG. 11, in the waveguide according to the present exemplary embodiment, the core 1101 with a periodic structure is formed on the cladding 1102 having a flat surface to form a component of the waveguide. It is desirable that the surface flatness of the cladding 1102 have a root square average roughness of less than 5 nm for reducing the loss in the total reflection at the interface between the core and the cladding.

A substrate 1103 is optionally used to hold the components of the waveguide including the core and the cladding to maintain the mechanical strength of the waveguide. In FIG. 11, the surface roughness of the core with a periodic structure is exaggerated. In the X-ray waveguide according to the present exemplary embodiment, the plural waveguide components are held with the core set to an inner side thereof.

In this description, the case in which the number of the components is 2 is described. The substrate of the first component is fixed on a holder 1106. The holder 1106 may be basically in a fixed state. However, the holder is preferably fixed on a movable stage (not illustrated) that can control the angle and translation position of the first component to adjust the position and incident angle of X-rays.

Meanwhile, the substrate of the second component is fixed on a stage 1107 which has a mechanism to precisely control the spatial position. Because high position control resolution and precision are required for the stage, a piezo actuator is preferably used as the driving unit.

In the X-ray waveguide according to the present exemplary embodiment, the positional relationship, that is, a relative position, between the first component and the second component is controlled. When the positional relationship between the first component and the movable second component is not controlled, the two periodic structures function as separate periodic structures that cause interference of X-rays, but propagation of X-rays on the periodic resonance waveguide mode cannot be achieved.

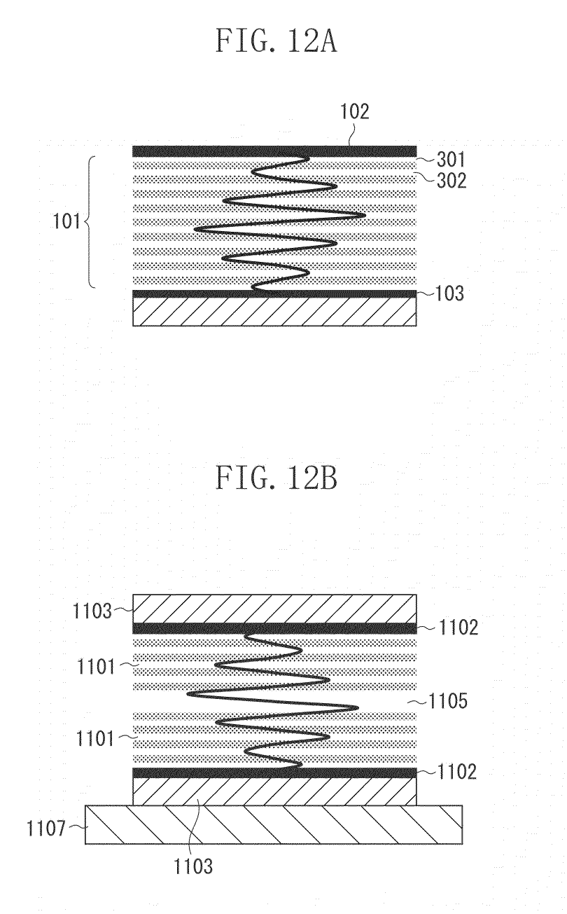

To achieve the periodic resonance waveguide mode, as schematically illustrated in FIG. 12A, the X-rays scattered at the interfaces between the materials having different real part of refractive index in the periodic structure need to be confined in the core by total reflection at the interface between the core and the cladding to cause the multiple interference so as to the nodes of the electric field are located in the low refractive index layer with a high electron density of the periodic structure and the antinodes of the electric field are located in the high refractive index layer with a low electron density in the periodic structure.

In the X-ray waveguide according to the present exemplary embodiment, the periodicity of each periodic structure can be in-phase each other by adjusting the stage 1107 to optimize the positional relationship between the two components. By the fine control of the positional relationship as described above, the two periodic structures function as one periodic structure, and consequently, the electric field as described above can be formed between the respective claddings of the two components, as illustrated in FIG. 12B. To enable this, the facing periodic structures need to have the same structural period.

There is no specific limitation for the gap 1105 between the facing core of each component. However, when the gap is more than 20 times the structural period, plural of modes of X-rays propagation through the space of the gap between the cores are generated, and the X-rays propagate at propagation angles in the vicinity of that of the desired periodic resonance waveguide mode. Accordingly, it becomes difficult to select the X-rays propagating on a single periodic resonance waveguide mode. The preferred gap between the cores of the components is less than 20 times the structure period of the cores, and more preferably less than 10 times the structure period of the cores. Here, the gap between the facing cores of the components refers to the distance between the uppermost surfaces of the facing cores.

Although the above description is about a configuration in which one component is fixed, similar effects can be achieved when both of the components are fixed on the mobile stages as long as the positional relationship between the two periodic structures can be precisely adjusted.

As described above, according to the present exemplary embodiment, even when the surface roughness of the core is somewhat large, it is possible to suppress the inevitable loss caused by the scattering when the cladding is directly formed on a surface of the core.

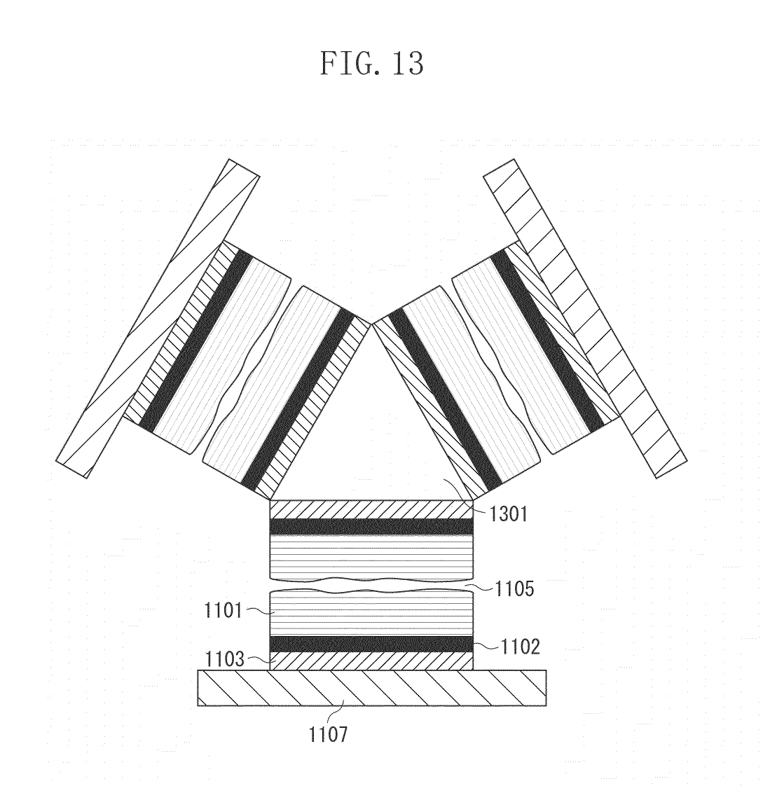

Also, although a case in which the number of the components is 2 has been described, the number of the components is not limited to 2. For example, it is possible to manufacture an X-ray waveguide by combining the plurality of configurations, as illustrated in FIG. 13.

In FIG. 13, for example, the waveguide components including a cladding having a flat surface and a core with a periodic structure formed on the cladding are fixed in three sides of a prism-shaped base 1301 having an equilateral triangular cross section, and the respective components are held so that another component fixed on the mobile stage faces with the surface of the core inward.

In this case, to control the incident angle and the incident position of X-rays, the triangular prism-shaped base is preferably fixed on a stage which can control the rotation and translation. In this case, a waveguide that propagate X-rays on three periodic resonance waveguide modes can be formed. However, when the structural periodicity in the three waveguide is changed, for example, it is possible to emit X-rays in different directions or emit X-rays having different wavelengths at the same angle by rotating the stage around the triangular prism-shaped base and switching the three waveguides.

A Bonse-Hart-type X-ray interferometer is known as an interferometer using a plurality of periodic structures. In this case, to make interfering X-rays by each periodic structures (crystals) coherent, the plural periodic structures need to be carved from a large single crystal.

In this case, because crystals have small structural periods, there is no control unit with sufficient resolution that enables the positional relationship between the plural separate crystals to be coherent. As a result, the plural periodic structures are inevitably formed from a single crystal. However, since the periodic structure used in the X-ray waveguides of the present exemplary embodiment have relatively large structure periods, the positional relationship between the separate periodic structures can be adjusted using a precise position control stage such as a piezo actuator so that all of the interfering X-rays can become coherent.

### Example 1

Hereinafter, the present invention will be described in further detail with reference to Examples. This Example is an example of the X-ray waveguide in which tungsten film is used as the cladding, a multilayer film made of B₄C and Al₂O₃ is used as the core, and the gap is under vacuum. Examples of a method for manufacturing an X-ray waveguide of this Example may include a process using a sputtering method as will be described below. An example of the X-ray waveguide illustrated in FIG. 8 is shown.

### (a) Formation of Cladding Layer

A tungsten film (cladding 103) with a thickness of 30 nm is formed on a silicon (Si) substrate (802 in FIG. 8) using magnetron sputtering.

### (b) Formation of a Multilayer Film (Core 101 in FIG. 8)

A multilayer film is manufactured by alternately forming films of Al₂O₃ (indicated by 301 in FIG. 8) and B₄C (indicated by 302 in FIG. 8) in this order using magnetron sputtering. Thicknesses of Al₂O₃ and B₄C are set to be 2.0 nm and 13.0 nm, respectively. The top and bottom layers of the multilayer film are Al₂O₃. 101 layers of Al₂O₃ and 100 layers of B₄C are formed.

### (c) Determination of the Length of the Waveguide

The multilayer film formed on the Si substrate is cut together with the Si substrate using a dicing device so that the length of the waveguide becomes 1 mm.

(d) Arrangement of the Cladding with a Driving Unit

A tungsten film (cladding 102) with a thickness of 30 nm formed using magnetron sputtering on a glass substrate 805 cut into a length of 1 mm is faced to the surface of the multilayer film. The position of the substrate with the tungsten film is changed by the driving stage 801 with the driving axes shown in FIG. 8.

The obtained X-ray waveguide has a configuration in which a core is sandwiched by the claddings, and X-rays are confined in the core through total reflection on the interface between the core and the cladding.

According to this configuration, the relationship between the Bragg angle for the periodicity of the multilayer film core and the critical angles for total reflection at the core-cladding and Al₂O₃/B₄C interfaces which are determined by the real part of a refractive indices of materials forming the core and the cladding satisfies θ_{B}<θ_{c-total} and θ_{c-multi}<θ_{B}. For example, θ_{c-total}=0.472° (a critical angle for total reflection at the interface between Al₂O₃ and tungsten), θ_{B}=0.295° and θ_{c-multi}=0.182° (critical angles for total reflection at the interface between Al₂O₃ and B₄C) for the X-rays of 8.04 keV. Under these conditions, X-rays are confined in the core by total reflection at the interface between the cladding and the core to form a periodic resonance waveguide mode.

Incident X-rays (energy: 8.04 key) are impinged to one of the end portion of the X-ray waveguide, and the interference pattern, which is formed by the interference of the X-rays emitted from the other end portion of the waveguide, is recorded using a two-dimensional X-ray detector at a camera length of 1,500 mm. The measurement system is placed under vacuum.

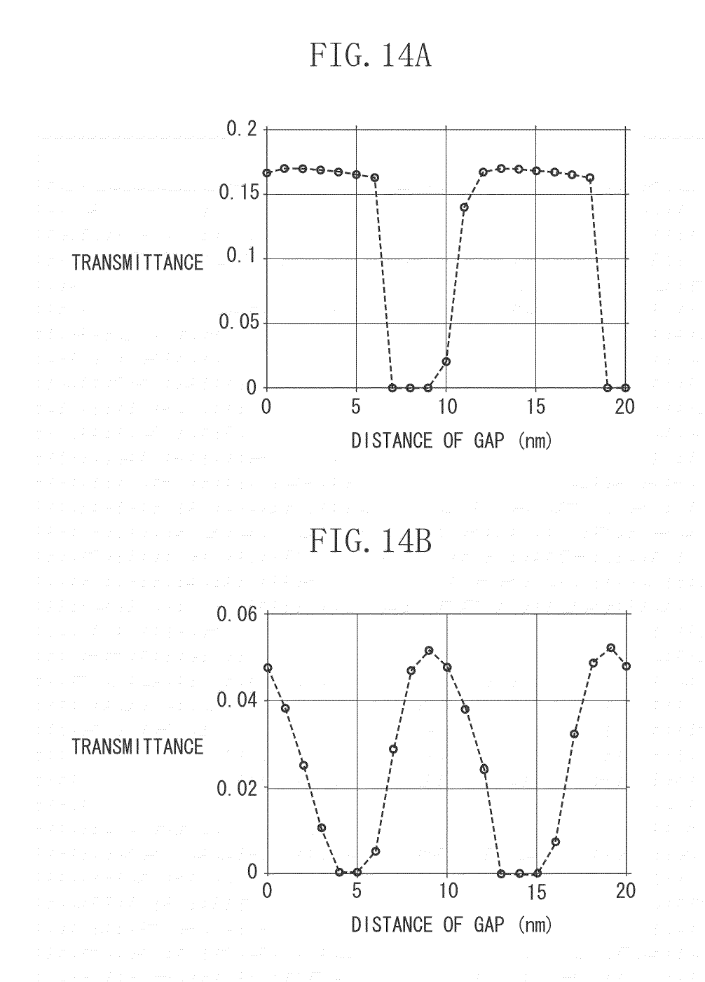

FIG. 14A shows the change in the transmittance of the X-ray waveguide of this Example when the spacing of the gap 104 is changed. It could be confirmed that, as the distance of the gap increases, the transmittance is periodically increased and decreased, and thus, the characteristics of the X-ray waveguide can be modulated according to the distance of the gap. When the ω axis of FIG. 8 is driven in a range of ±0.0002°, the similar change in the intensity of the X-rays emitted from the waveguide can be observed.

The similar characteristics of the waveguide as FIG. 14A can also be observed when the cladding 102 is fixed and the cladding 103 and the multilayer core 101 formed on a Si substrate are integrally driven by a piezo actuator to change the distance of the gap 104.

### Example 2

In the Example of the X-ray waveguide, tungsten is used as the cladding, mesoporous silica film is used as the core, and the gap is filled with air.

A mesoporous silica film with a two-dimensional periodic structure formed by regularly arranged cylindrical mesopores. Because of its preferred orientation, this mesoporous silica film has a periodic structure in the thickness direction. The method for manufacturing an X-ray waveguide of this Example using the mesoporous silica film as a core is described below.

### (a) Formation of the Cladding Layer

A tungsten film (cladding 103) is formed with a thickness of 20 nm on a Si substrate using magnetron sputtering.

### (b) Preparation of the Precursor Solution for the Mesostructured Silica Film

A mesostructured silica film is prepared by a dip coating method. A precursor solution is prepared as follows: 54.7 ml of tetraethoxysilane, 74.4 ml of ethanol, and 26.4 ml of 0.01 M hydrochloric acid are added in this order in a conical flask, and stirred. After 15 minutes, 49.6 ml of an ethanol solution containing 13.7 g of surfactant P123 (BASF) is added thereto. Thereafter, stirring is performed for 3 hours, and 12.0 ml of pure water is added.

### (c) Film Formation of Mesostructured Silica Film

A substrate sputtered with tungsten is dip-coated with the precursor solution prepared in (b) using a dip coating device (pulling rate: 0.5 mm per second). In this case, the temperature is 25° C., and the relative humidity is 5% or less. After the coating, the film is maintained for 18 hours in a constant temperature/humidity chamber at 25° C. and relative humidity of 40%. Thereafter, P123 (BASF) is removed by solvent extraction using ethanol to transform into a mesoporous silica film. FIG. 8 is a simplified plane view. (d) Characterization of the mesoporous silica film

The manufactured mesostructure film is characterized by θ-2θ scanning X-ray diffraction under the Bragg-Brentano geometry. As a result, it is confirmed that the mesosporou silica film has structural regularity in a normal direction of the substrate surface, and the structure period in this confinement direction is estimated to be 10.2 nm. The thickness of the film is approximately 480 nm.

### (e) Determination of the Length of the Waveguide

The X-ray waveguide is cut using a dicing device so that the length of the waveguide becomes 1 mm.

### (f) Arrangement of a Mobile Cladding

A tungsten film (cladding 102) having a thickness of 30 nm is formed using magnetron sputtering on a glass substrate 805 cut into a length of 1 mm is faced to the surface of the mesoporous silica film. A position of the tungsten on the substrate can be changed by the driving stage 801 with the driving axes shown in FIG. 8.

Since the mesoporous silica film that is the core in this X-ray waveguide has a period of 10.2 nm, θ_{B}<θ_{c-total} and θ_{c-multi}<θ_{B} are satisfied. For example, θ_{c-total}=0.515° (a critical angle for total reflection at the interface between silica and tungsten), θ_{B}=0.433° and θ_{c-multi}=0.201° (critical angles for total reflection at the interface between silica and air) for the X-rays of 8.04 keV, and the X-rays are confined in the core by total reflection at the interface between the cladding and the core to form a periodic resonance waveguide mode.

The incident X-rays (energy: 8 keV) are impinged to one of the end portion of the X-ray waveguide, and the interference pattern, which is formed by the interference of the X-rays emitted from the other end portion of the waveguide, is recorded using a two-dimensional X-ray detector at a camera length of 1,500 mm. The measurement system is kept under an air condition with an ambient pressure.

FIG. 14B shows the change in the transmittance of the X-ray waveguide of this Example when the distance of the gap 104 is changed. It could be confirmed that, as the distance of the gap increases, the transmittance is periodically increased and decreased, and thus, the characteristics of the X-ray waveguide may be modulated according to the distance of the gap. When the ω axis of FIG. 8 is driven in a range of ±0.0002°, the similar change in the intensity of the X-rays emitted from the waveguide can be observed.

The similar characteristics of the waveguide as FIG. 14A can also be observed when the cladding 102 is fixed and the cladding 103 and the mesoporous silica film core 101 formed on a Si substrate are integrally driven by a piezo actuator to change the spacing of the gap 104.

In this Example, when the extraction rate of P123 (BASF) is lowered in the preparation of the mesoporous silica film, the intensity of guided X-rays is reduced, but the characteristics of the periodic resonance waveguide mode and the modulation characteristics can be observed more clearly.

### Example 3

This Example is an example in which the propagation of X-rays through the periodic resonance waveguide mode is enabled by facing two waveguide components, in which a mesostructured silica film prepared using a non-ionic surfactant as a structure directing agent is formed on a tungsten cladding on a silicon substrate, and by finely controlling the gap. Fixing the first component relative to the incident X-rays and the position of the second component relative to the first component is precisely controlled using a stage which is driven by a piezo actuator.

A tungsten film is formed with a thickness of 20 nm on a surface of each of two silicon substrates using sputtering, and used as the cladding. The surface of the tungsten film has high flatness, which means that a root square average roughness, measured using an atomic force microscope (AFM), is less than 1.0 nm.

A mesostructured silica film is formed on this cladding. Pluronic P123 is used for the surfactant. The precursor solution used for the preparation of the mesostructured silica film is prepared by mixing solution A, which is prepared by adding 26.4 ml of 0.01 M dilute hydrochloric acid to a solution obtained by dissolving 54.7 ml of tetraethoxysilane (TEOS) in 74.4 ml of ethanol, and solution B, which is prepared by dissolving 13.7 g of P123 in 49.6 ml of ethanol, and finally adding 12.0 ml of pure water. A silicon substrate, on which the tungsten cladding, is dip-coated with the precursor solution a pulling rate of 0.5 mm/s, and dried at 40° C. for 24 hours to obtain a mesostructured silica film.

From X-ray diffraction analysis and X-ray reflectance measurement, it is confirmed that the mesostructured silica film prepared as described above has a structure period of 10.1 nm and the number of layers is 42. From the observation using an electron microscope, it is also apparent that the mesostructured silica film has a two-dimensional hexagonal structure having cylindrical micelles.

The periodic structures are the same in two components. Using an atomic force microscope, the surface roughness of the mesostructured silica film is estimated that the root square average of the roughness is 11 nm. The two components have a size of 3 mm in a waveguide direction of X-rays (Y direction in FIG. 8).

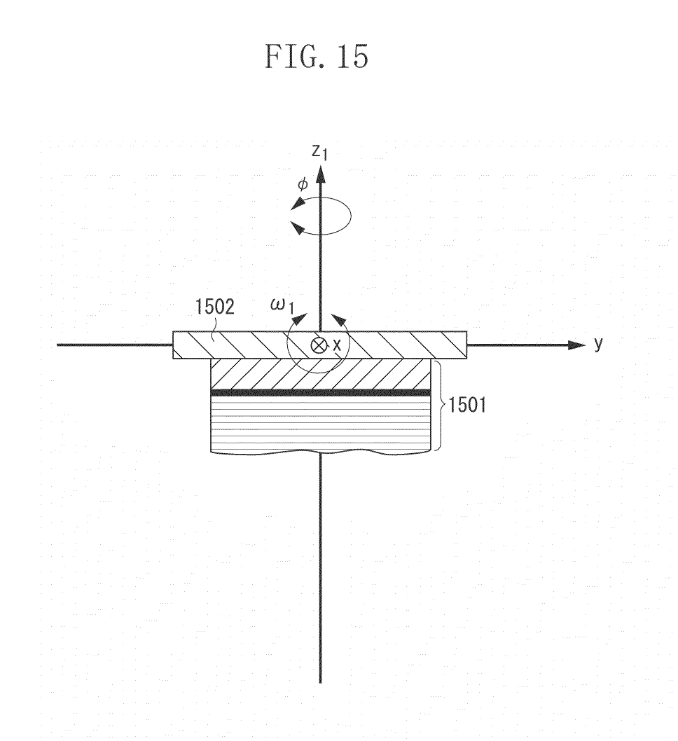

As illustrated in FIG. 15, one (first component 1501) of the two components is fixed on a holder, and the holder is fixed on a ω₁, z₁ movable stage 1502 to control the incident angle and the position of X-rays for the first component.

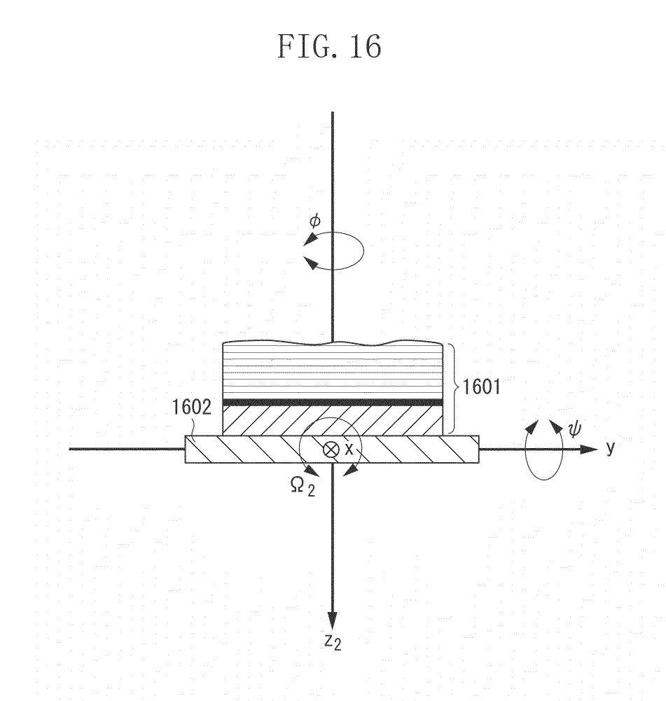

As illustrated in FIG. 16, the other (second component 1601) of the two components is fixed on a precise mobile stage 1602 driven by a piezo actuator. The mobile stage allows the precise control of the ω and the ψ rotations and the z translation, as illustrated in FIG. 16.

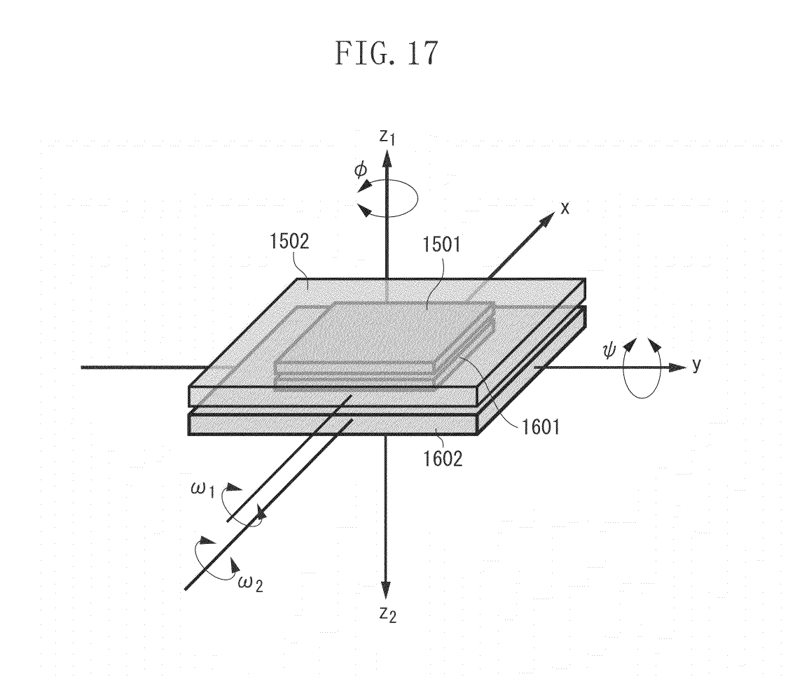

It is favorable that the stage can control the in-plane rotation angle φ and the translations in an the x and y directions. However, High resolution for movement in these axial directions is not required. FIG. 17 is a schematic diagram illustrating the whole configuration and control axis of the waveguide.

First, the position alignment for X-rays is performed on the first component fixed to the ω₁, z₁ stage by a holder, as illustrated in FIG. 15. This adjustment is performed by adjusting the position z₁ and angle ω₁ so that the surface of the periodic structure of the first component partially blocks the beam of the incident X-rays in a direction parallel to the beam to reduce the intensity of the incident X-rays to be nearly ½. The X-rays used are MoKα radiation with a photon energy of 17.5 keV.

From the position set by the above procedure, the first component is rotated around the incident position of the X-rays to set the incidence angle to be 0.2°. This is the angle at which the propagation of X-rays takes place on the periodic resonance waveguide mode, and is slightly smaller than the Bragg angle corresponding to the structure period of 10.1 nm of the mesostructured silica film.

This angle is smaller than the critical angle for total reflection when the same X-rays of 17.5 keV are incident to the tungsten layer from the mesostructured silica layer, and the X-rays propagating in the core at the propagation angle are confined in the waveguide by the cladding layer.

The position of the second component is adjusted with respect to the first component, whose position is determined as described above. First, the second component fixed to the mobile stage faces the first component, so that the core surfaces of the first component and the second component are uniformly contact with each other using a coarse motion mode. From this situation, the z axis of a piezo stage is shifted by 20 nm, and the X-ray waveguide is manufactured so that the first and second components face each other with a small gap between the core surfaces of the first and second components.

Here, the z, ω and ψ axes of the piezo stage, on which the second component is held, are finely adjusted so that the intensity of the X-rays that transmitted the waveguide becomes maximum by monitoring the X-rays using a detector. At the position at which the intensity of the transmitted X-rays become maximum, the lattices of the periodic structures in the first and second components becomes parallel. In addition, the phases of the respective periodic structures match each other.

Finally, the ω axes of both of the components are precisely rotate synchronously to determine the incident angle at which the intensity of the transmitted X-rays becomes the maximum. Since the incident angle of X-rays is a very small angle of approximately 0.2°, the arrangement in which the X-rays are incident at an angle nearly perpendicular to the end face of the waveguide is obtained.

The far field pattern of the X-rays emitted from the waveguide whose position is adjusted as described above is observed using a two-dimensional X-ray detector. As a result, it is confirmed that the X-rays emitted from the waveguide are coherent in the thickness direction of the waveguide.

In this Example, even when a silica mesostructure in which a root square average roughness of the core surface exceeds 10 nm is used as the core, it is revealed that propagation of the X-ray through the good periodic resonance waveguide mode can be achieved using the configuration according to the present invention.

### Example 4

This Example 4 is an example in which X-ray propagation based on the periodic resonance waveguide mode is enabled by facing two waveguide components in which a boron carbide (B₄C)/alumina (Al₂O₃) alternate stacking film is formed on a tungsten cladding which is formed on a silicon single crystal substrate, fixing the first component relative to the incident X-rays, and precisely controlling a position of the second component relative to the first component using a stage which is driven by a piezo actuator.

A tungsten film is formed to a thickness of 20 nm on a surface of each of two silicon substrates using sputtering, and used as the cladding portion. A surface of the tungsten film has high flatness, which indicates that a root square average roughness is less than 1.0 nm, as measured using an atomic force microscope.

Also, an alternate stacking film of boron carbide and alumina is formed on the tungsten film by sputtering. A film thickness of B₄C is 12 nm, and a film thickness of Al₂O₃ is 3 nm, which indicates that the structure period is 15 nm and the total number of layers is 100. A material adjoining tungsten is Al₂O₃. In this film formation process, the two components of the X-ray waveguide are manufactured. The surface roughness of the multilayer film is evaluated using an atomic force microscope. As a result, it is apparent that the root square average roughness is approximately 7 nm. The two components have a size 4 mm in a waveguide direction of X-rays.

Like Example 3, one (first component) of the two components is fixed to a holder, and the holder is fixed on a z₁ movable stage to control the incidence angle and incidence position of X-rays for the first component.

Also, like Example 3, the other (second component) is fixed on a precise movable stage driven by a piezo actuator. The same movable stage of the piezo actuator as in Example 3 is used.

First, the position alignment for incident X-rays is performed on the first component in a similar procedure as in Example 3. As described in Example 1 above, this adjustment is performed by adjusting the position of a surface of the periodic structure of the first component to block an optical path of incident X-rays in a direction parallel to the optical path, so that the intensity of the incident X-rays nearly become ½. The X-rays used are MoKα rays which have an energy value of 17.5 keV.

From the position, the first component is rotated around the incidence position of X-rays, so that the incidence angle is set to an angle of 0.135°, which is slightly smaller than an angle at which propagation of X-rays takes place through the periodic resonance waveguide mode, that is, a Bragg angle corresponding to a structure period of 15 nm of the multilayer film. The angle is smaller than the critical angle for total reflection when the same X-rays of 17.5 keV are incident to the tungsten layer from the alumina layer, and the X-rays propagating in the core at the propagation angle are confined in the waveguide by means of the cladding layer.

In this way, the position of the second component is adjusted in a similar procedure as in Example 3 for the first component whose position is determined. First, the second component fixed to the movable stage faces the first component, and core surfaces of the first component and the second component are brought into uniform contact with each other in a coarse motion mode. From this situation, the z axis of a piezo stage is shifted by 20 nm, so that the first and second components face each other via a minute gap between the core surfaces of the first and second components.

Here, the z, ω and ψ axes of the piezo stage on which the second component is held are finely adjusted so that X-rays become the maximum X-ray transmission intensity while irradiating the waveguide with the X-rays and monitoring the X-rays using a detector. At a position in which the X-rays become the maximum X-ray transmission intensity, the periodic structures of the first component and the second component have parallel lattice surfaces forming the periodic structure. In addition, the periodic phases match each other in the respective periodic structures.

Finally, as described above, the ω axes of both of the components are synchronized to precisely rotate the components at a fine angle while irradiating the waveguide with X-rays, and the incidence angle at which X-rays become the maximum intensity is determined. In this case, since the incidence angle of X-rays is a very small angle of approximately 0.14°, the arrangement in which the X-rays are incident at an angle nearly perpendicular to an end face of the waveguide is obtained.

The far field pattern of X-rays emitted from the waveguide whose position is adjusted as described above is observed using a two-dimensional X-ray detector. As a result, it is confirmed that phases of the X-rays emitted from the waveguide are coherent in a thickness direction of the waveguide.

In this Example, even when a multilayer film having a relatively coarse surface, in which a root square average roughness of the core surface is 7 nm, is used as the core, it is revealed that propagation of the X-ray through the good periodic resonance waveguide mode may be achieved using the configuration according to the present invention.

### Example 5

This Example is an example in which propagation of X-rays through the periodic resonance waveguide mode is enabled by facing two waveguide components in which a mesoporous silica mesostructure film, which is manufactured using a non-ionic surfactant as a structure directing agent, is formed on a tungsten cladding which is formed on a quartz glass base, fixing the first component relative to incident X-rays, and precisely controlling a position of the second component relative to the first component using a stage which is driven by a piezo actuator.

A tungsten film is formed to a thickness of 20 nm on a surface of each of two quartz glass substrates using sputtering, and used as the cladding portion. A surface of the tungsten film has high flatness, which indicates that a root square average roughness is approximately 1.8 nm, as measured using an atomic force microscope.

The same silica mesostructure film as used in Example 1 is manufactured on the tungsten film in the similar sequence as in Example 1. The precursor solution is deep-coated at a pulling rate of 0.5 mm/s on the quartz substrate having the tungsten film formed thereon, and dried at 50° C. for 60 hours to obtain a silica mesostructure film.

The silica mesostructure film manufactured as described above is immersed in ethanol, and the surfactant is extracted and removed. The removal of the surfactant is confirmed from the fact that an absorption peak derived from a C—H bond disappears from the infrared absorption spectra.

By the X-rays diffraction analysis and X-rays reflexibility measurement, it is confirmed that, after the extraction of the surfactant, the mesoporous silica thin film has a structure period of 9.8 nm, and the number of layers is 42. By the observation using an electron microscope, it is also apparent that the mesoporous silica thin film has a two-dimensional hexagonal structure including cylindrical fine mesopores. The mesoporous silica films having such a periodic structure are similar in two components. When the surface roughness of the silica mesostructure thin film is evaluated under an atomic force microscope, it is apparent that the root square average roughness is 12 nm. The two components have a size of 5 mm in a waveguide direction of X-rays.

Like Examples 3 and 4, one (first component) of the two components is fixed to a holder, and the holder is fixed onto a ω₁, z₁ movable stage to control the incidence angle and incidence position of X-rays for the first component.

Meanwhile, the second component is fixed on a precise movable stage driven by a piezo actuator. The same movable stage of the piezo actuator as in Examples 1 and 2 is used.

First, the position alignment for incident X-rays is performed on the first component in a similar procedure as in Example 3. As described in Example 1 above, this adjustment is performed by adjusting the position so that a surface of the periodic structure of the first component blocks an optical path of incident X-rays in a direction parallel to the optical path to reduce the intensity of the incident X-rays to be nearly ½. The X-rays used are CuKα rays which has an energy value of 8.0 keV.

From the position, the first component is rotated around the incidence position of X-rays, and the incidence angle is set to an angle of 0.45°, which is slightly smaller than an angle at which propagation of X-rays takes place through the periodic resonance waveguide mode, that is, a Bragg angle corresponding to a structure period of 9.8 nm of the multilayer film.

The angle is smaller than the critical angle for total reflection when the same X-rays having an energy value of 8 keV are incident to the tungsten layer from the mesoporous silica layer, and the X-rays propagating in the core at the propagation angle are confined in the waveguide by means of the cladding layer.

In this way, the position of the second component is adjusted in a similar procedure as in Examples 3 and 4 for the first component whose position is determined. First, the second component fixed to the movable stage faces the first component, and core surfaces of the first component and the second component are brought into uniform contact with each other in a coarse motion mode.

From this situation, the z axis of a piezo stage is shifted by 20 nm, and the first component and the second component face each other via a minute gap between the core surfaces of the first component and the second component.

Here, the z, ω and ψ axes of the piezo stage on which the second component is held are finely adjusted so that X-rays can become the maximum X-ray transmission intensity while irradiating the waveguide with the X-rays and monitoring the X-rays using a detector. At a position in which the X-rays reach the maximum X-ray transmission intensity, the periodic structures of the first component and the second component have a parallel lattice surfaces forming the periodic structure. In addition, the periodic phases match each other in the respective periodic structures.

Finally, as described above, the ω axes of both of the components are synchronized to precisely rotate the components at a fine angle while irradiating the waveguide with X-rays, and the incidence angle at which X-rays reach the maximum intensity is determined. In this case, the incidence angle of X-rays is a very small angle of approximately 0.45°.

The far field pattern of X-rays emitted from the waveguide whose position is adjusted as described above is observed using a two-dimensional X-ray detector. As a result, it is confirmed that phases of the X-rays emitted from the waveguide are coherent in a thickness direction of the waveguide.

In this Example, even when a mesoporous silica film in which a root square average roughness of the core surface exceeds 10 nm is used as the core, it is revealed that propagation of the X-ray through the good periodic resonance waveguide mode may be achieved using the configuration according to the present invention.

The X-ray waveguide according to the present invention can provide X-ray beams having coherent phases, and also control the waveguide characteristics such as transmittance. Hence, the X-ray waveguide according to the present invention can be useful in the analysis technology or imaging technique, both of which use X-rays.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2011-206998 filed Sep. 22, 2011 and No. 2011-227973 filed Oct. 17, 2011, which are hereby incorporated by reference herein in their entirety.

What is claimed is:

1. An X-ray waveguide comprising:
a core having a periodic structure in which basic structures made of a plurality of substances having different real parts of refractive indexes are periodically disposed;
claddings formed on the outer side of the core to confine X-rays in the core through total reflection,
a gap formed at least a portion between the cladding and the core; and
a driving unit configured to drive at least a portion of the cladding or the core to change the distance of the gap,
wherein the critical angle for total reflection of the X-rays at the interface between the cladding and the gap is larger than the Bragg angle corresponding to the structural period of the core, and the critical angle for total reflection at the interface between the plurality of the substances having different real parts of refractive indexes, which form the periodic structure of the core, is smaller than the Bragg angle.

2. The X-ray waveguide according to claim 1, wherein the gap is filled with a fluid or is under vacuum.

3. The X-ray waveguide according to claim 1, wherein the driving unit changes the distance of the gap by driving at least a portion of the cladding or by driving a portion other than the said portion of the clad.

4. The X-ray waveguide according to claim 1, wherein the driving unit is a piezo actuator.

5. The X-ray waveguide according to claim 1, wherein the periodic structure of the core has a number of periods of 20 or more.

6. The X-ray waveguide according to claim 1, wherein the core is an inorganic multilayer film or an organic-inorganic mesostructured film or a mesoporous materials film.

7. The X-ray waveguide according to claim 1, wherein at least one of the plurality of substances having different real parts of refractive indexes is an oxide.

8. An X-ray waveguide comprising:
a plurality of components which include a cladding portion and a core portion in which a plurality of substances having different real parts of refractive indexes are periodically disposed on the cladding portion, wherein the critical angle for total reflection at the interface between the cladding portion and the core portion is larger than the Bragg angle corresponding to the structural period of the core portion for X-rays with the same wavelengths, and the critical angle for total reflection at the interface between the plurality of substances having different real parts of refractive indexes, which form the core portion, is smaller than the Bragg angle; and
a position control unit configured to control the positional relationship between at least one of the first component of the plurality of components and the second component facing the first component,
wherein the plurality of components face each other with the core portions set to an inner side thereof, and the structural period of the core portions of the facing components is the same to each other.

9. The X-ray waveguide according to claim 8, wherein the position control unit is a piezo actuator.

10. The X-ray waveguide according to claim 8, wherein the core portions of the first component and the second component have structural periodicity in a direction perpendicular to the surface of the cladding portion.

11. The X-ray waveguide according to claim 8, wherein the core portions of the first component and the second component have a one-dimensional periodic structure in which the plurality of substances having different real parts of refractive indexes are periodically stacked.

12. The X-ray waveguide according to claim 8, wherein the core portions of the first component and the second component are organic-inorganic mesostructured films.

13. The X-ray waveguide according to claim 8, wherein the core portions of the first component and the second component are mesoporous materials films.

14. The X-ray waveguide according to claim 12, wherein the core portions of the first component and the second component are formed by self-assembly of amphiphilic materials.

15. A method for manufacturing an X-ray waveguide comprising:
preparing a component of an X-ray waveguide by forming a core portion in which a plurality of substances having different real parts of refractive indexes are periodically formed on a cladding portion;
disposing the plurality of the components having the core portions with the same structural period so as to face the core portions each other; and
installing a mechanism capable of controlling the positional relationship between at least one of the first components and the second component facing the first component.

16. A method for controlling an X-ray waveguide in which a plurality of components, which includes cladding portions and a core portion in which a plurality of substances having different real parts of refractive indexes are periodically formed on the cladding portion comprising:
disposing the plurality of components so as to facing the core portions each other, and
controlling the positional relationship between at least one of the first components and the second component facing the first component, and
resonating X-rays to be guided based on the periodic structure of the core portion.
